(19) United States
(12) Patent Application Publication
(10) Pub. No.: US 2008/0095484 A1
(43) Pub. Date: Apr. 24, 2008

(54) CENTER BEARING SUPPORT

(75) Inventors: Todd M. Wirges, Ann Arbor, MI (US); Paul M. Fernandez, Northville, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/552,421

(22) Filed: Oct. 24, 2006

(51) Int. Cl. F16C 27/00

(52) U.S. Cl. 384/536

(57) ABSTRACT

A center bearing support providing improved impact harshness, load capacity, and long term fatigue durability through the introduction of a tunable stopper element which allows greater control as the excitation levels of a supported shaft are increased, including an inner element installed on the inner periphery surface of an outer element fixed to a body side through an elastic body made of elastomer material and a center bearing or bushing installed on the inner peripheral surface of the inner element, wherein a stopper extending convergently is formed at the end part of the flexible main body of the elastic body, and a rib is formed between the stopper and the end part of the flexible main body at a specific phase interval, whereby, because a deformation force given by the contact of the stopper with the outer ring when an excessive displacement is input is absorbed by the displacement of the end part of the flexible main body, an abrupt rise of a spring constant can be suppressed.

### FIELD

The present disclosure relates to a center bearing support which elastically supports a concentric spinning ball bearing, which in turn supports a propeller shaft providing isolation and control of the propshaft system relative to the vehicle body.

### BACKGROUND AND SUMMARY

The statements in this section merely provide background information related to the present disclosure and may not constitute prior art.

A center bearing support is structured such as to elastically support a center bearing (ball bearing, bushing, or otherwise) mounted to the outer periphery at a predetermined position in the axial direction of a propeller shaft (not shown) of a motor vehicle to the vehicle body (or frame), thereby restricting vibration transmission of the propeller shaft during traveling, reducing vibration transmission between the propeller shaft and the vehicle body, and reducing noise produced by the subsystem.

The present disclosure is directed to a center bearing support including a bearing assembly received within an inner element and a flexible elastic element connecting the inner element to an outer element for isolating vibrations from being transmitted from the bearing assembly to the outer element. A separate stopper element is provided between the inner and outer elements to provide shock absorption between the inner and outer elements. The stopper may be formed of any material or geometry as required by the application.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view showing an embodiment of a center bearing support in accordance with the principles of the present disclosure;

FIG. 2 is a cross sectional view along a line 2-2 in FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

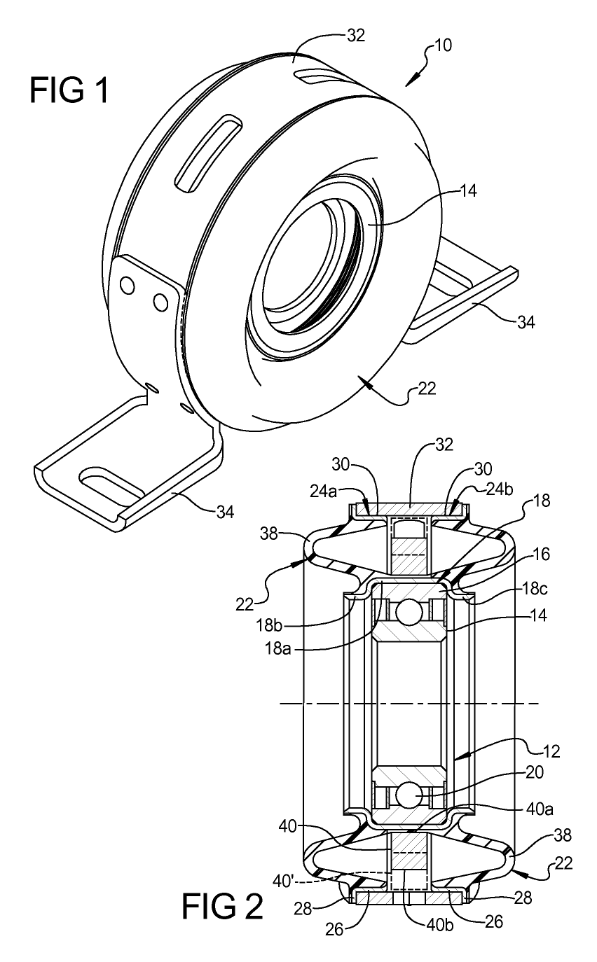

With reference to FIGS. 1 and 2, a center bearing support 10 is shown including a bearing assembly 12 adapted to receive a propeller shaft (not shown). The bearing assembly 12 can be any rotational support structure including a ball or needle bearing assembly or a bushing. The bearing assembly 12 includes an inner race 14 which has an inner diameter that engages the propeller shaft. An outer race 16 of the ball bearing assembly is supported by an inner element 18. The inner element 18 can be ring-shaped or have other shapes. A plurality of balls (or, alternatively, rollers or a bushing) 20 are supported between the inner and outer races 14,16, respectively.

The inner element 18 surrounds the bearing assembly 12 and includes a center portion 18a and first and second radially inwardly extending flange portions 18b, 18c straddling the bearing assembly 12. The inner element 18 can be formed as a single element or can be formed of two element halves split along the center portion 18a. In addition, it should be understood that the inner element 18 can be integrated with, or part of, the outer race 16 of the bearing assembly 12.

A pair of molded flexible elastic elements 22 are attached at an inner diameter to opposite sides of the inner element 18. The elastic elements 22 are also attached at an outer diameter to a pair of outer elements 24a, 24b, respectively. Outer elements 24a, 24b can each include a cylindrical axially extending portion 26 and a radially outwardly extending portion 28 extending from outer ends of said axially extending portions 26. The outer elements 24a, 24b can be ring-shaped or can have other shapes. The outer elements 24a, 24b each have an outer surface 30 that are pressed into opposite ends of an annular bracket 32. The annular bracket 32 is adapted to be mounted to a vehicle frame or body by a pair of mounting brackets 34.

The elastic elements 22 each include an outwardly bowed center portion 38 and are formed from a flexible elastomeric material which is molded to, or otherwise bonded or affixed to, the inner element(s) 18 and outer elements 24a, 24b. The elastic elements 22 can be formed from any material that is flexible so as to isolate vibration of the propeller shaft from the vehicle frame and body and to restrict vibration of the propeller shaft.

A bumper element 40 surrounds the bearing assembly 12 and is disposed between the inner element(s) 18 and annular bracket 32. The bumper element 40 is preferably formed from micro-cellular urethane (MCU), although other materials may be used. The bumper element 40 radially restricts the motion of the bearing assembly 12 relative to the annular bracket 32 so as to prevent damage to the center bearing support and to reduce noise and vibration. The micro-cellular urethane bumper element 40 exhibits a steadily increasing spring constant or load resistance under compression so as to provide sufficient shock absorption without a sudden increase in the spring constant. The exact shape, material/density, and geometry of this bumper element can be tuned and optimized as best suiting a given application to arrive at the desired travel and load management behaviors for the part.

The bumper element 40 has an inner diameter 40a which can be substantially the same as an outer diameter of the center portion 18a of inner ring(s) 18. The outer diameter 40b of the bumper element 40 can be selected to provide clearance between the annular bracket 32 and the bumper element 40 if desired, or can be approximately equal to the inner diameter of the annular bracket 32 depending upon the desired vibration characteristics. It is also anticipated that the inner diameter 40a of bumper element 40 can be spaced from the inner element 18. Also, adhesives or other retaining features can be utilized to maintain the bumper element 40 in its generally centered position. Additionally, as shown in phantom lines in FIG. 2, the bumper element 40 can be designed, such that, the outer diameter 40b can be substantially the same as the inner diameter of the annular bracket 32. The inner diameter 40a of the bumper element 40′ can then be selected to provide clearance between the outer diameter of the center portion 18a of inner element 18 and the bumper 40 if desired, or can be approximately equal to the outer diameter of the center portion 18a of inner element 18 depending upon the desired vibration characteristics.

What is claimed is:

1. A center bearing support, comprising:
a rotational support structure;
an inner element surrounding said rotational support structure;
an elastic element having an inner portion connected to said inner element;
an outer element connected to an outer portion of said elastic element; and
a bumper formed separately from said elastic element and disposed between said inner element and said outer element.

2. The center bearing support according to claim 1, wherein said bumper element is formed from microcellular urethane.

3. The center bearing support according to claim 1, wherein said bumper element is retained between said inner element and said outer element.

4. The center bearing support according to claim 1, wherein said bumper element has an inner diameter substantially equal to an outer diameter of said inner element.

5. The center bearing support according to claim 1, wherein said bumper element has an outer diameter substantially equal to an inner diameter of said outer element.

6. The center bearing support according to claim 1, wherein an outer diameter of said bumper element is spaced inwardly from said outer element.

7. The center bearing support according to claim 1, wherein an inner diameter of said bumper element is spaced outwardly from said inner element.

8. The center bearing support according to claim 1, wherein said bumper element is fixed in place by an adhesive.

9. A center bearing support, comprising:
a bearing assembly having an inner race and an outer race with a plurality of rolling members disposed between said inner race and said outer race;
an inner ring surrounding said outer race;
a first elastic seal member having a radially inner portion attached to a first end of said inner ring;
a second elastic seal member having a radially inner portion attached to a second end of said inner ring;
a first outer ring attached to a radially outer portion of said first elastic seal member;
a second outer ring attached to a radially outer portion of said second elastic seal member;
an annular bracket attached to said first outer ring and said second outer ring; and
a bumper formed separately from said first and second elastic seal members and disposed between said inner ring and said annular bracket.

10. The center bearing support according to claim 9, wherein said bumper is formed from microcellular urethane.

11. The center bearing support according to claim 9, wherein said bumper is retained between said inner element and said annular bracket.

12. The center bearing support according to claim 9, wherein said bumper has an inner diameter substantially equal to an outer diameter of said inner element.

13. The center bearing support according to claim 8, wherein said bumper has an outer diameter substantially equal to an inner diameter of said outer element.

14. The center bearing support according to claim 9, wherein an outer diameter of said bumper is spaced inwardly from said outer ring.

15. The center bearing support according to claim 9, wherein an inner diameter of said bumper is spaced outwardly from said inner element.
